(19) United States
(12) Patent Application Publication
(10) Pub. No.: US 2004/0036872 A1
(43) Pub. Date: Feb. 26, 2004

(54) Apparatus for spectral selection and detection of a light beam, and scanning microscope

(75) Inventor: Johann Engelhardt, Bad Schoenborn (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Heidelberg GmbH, Mannheim (DE)

(21) Appl. No.: 10/645,690

(22) Filed: Aug. 20, 2003

(30) Foreign Application Priority Data
Aug. 21, 2002 (DE) DE 102 38 100.3

(51) Int. Cl. G01J 3/28

(52) U.S. Cl. 356/326

(57) ABSTRACT

An apparatus for selection and detection of at least two spectral regions of a light beam is disclosed. The light beam is spectrally spread and focused into a focus line. The apparatus has means, modifiable in their position parallel to the focus line, for blocking out a first spectral region and for reflecting at least a portion of the unblocked spectral region and a detection device that encompasses means for detecting the first spectral region and means for detecting the reflected spectral region, whereby the detection device is arranged in a plane perpendicular to the focus line.

### CROSS REFERENCE TO RELATED APPLICATIONS

This application claims priority to German patent application 102 38 100.3, the subject matter of which is hereby incorporated by reference herein.

### FIELD OF THE INVENTION

The invention concerns an apparatus for selection and detection of at least two spectral regions of a light beam.

The invention furthermore concerns a scanning microscope having an apparatus for selection and detection of at least two spectral regions of a light beam.

### BACKGROUND OF THE INVENTION

An apparatus for selection and detection of at least two spectral regions of a light beam is known from German Unexamined Application DE 43 30 347 A1. For reliable simultaneous selection and detection of different spectral regions with high yield and with the simplest possible design, the apparatus having a selection device and a detection device is configured in such a way that the selection device encompasses means for spectral subdivision of the light beam and means on the one hand for blocking out a first spectral region and on the other hand for reflecting at least a portion of the unblocked spectral region, and the detection device encompasses a first detector arranged in the beam path of the blocked-out first spectral region, and a second detector arranged in the beam path of the reflected spectral region. DE 199 02 625 A1 discloses an apparatus for simultaneous detection of several spectral regions of a light beam, in particular for detection of the light beam of a laser scanner in the detection beam path of a confocal microscope. In order to achieve a simple configuration with small overall size while avoiding the defocusing effect, the apparatus is characterized by an arrangement for spectrally spreading the light beam and an arrangement for splitting the spread-out beam out of the dispersion plane into spectral regions and for subsequent detection of the divided spectral regions. German Unexamined Application DE 100 06 800 A1 discloses an apparatus for selection and detection of at least one spectral region of a spectrally spread light beam, preferably in the beam path of a confocal scanning microscope, the spreadout light beam being focusable into a focal line; for non-overlapping detection of the spectrally spread-out light beam of the selected spectral regions in the context of an elevated number of detectors and a fault-tolerant arrangement, it is characterized in that there is arranged in the spread-out light beam an optical component which reflects and/or refracts the light beam to a detector and whose optically effective region can be smaller or larger along the surface, so that by alignment of the component with respect to the focal line and the resulting superposition of the focal line and surface, the spectral region arriving at the detector can be defined.

In scanning microscopy, a sample is illuminated with a light beam in order to observe the reflected or fluorescent light emitted from the sample. The focus of an illuminating light beam is moved in a specimen plane by means of a controllable beam deflection device, generally by tilting two mirrors, the deflection axes usually being perpendicular to one another so that one mirror deflects in the X direction and the other in the Y direction. Tilting of the mirrors is brought about, for example, by means of galvanometer positioning elements. The power level of the detection light coming from the specimen is measured as a function of the position of the scanning beam. The positioning elements are usually equipped with sensors to ascertain the present mirror position.

In confocal scanning microscopy specifically, a specimen is scanned in three dimensions with the focus of a light beam. A confocal scanning microscope generally comprises a light source, a focusing optical system with which the light of the source is focused onto an aperture (called the “excitation pinhole”), a beam splitter, a beam deflection device for beam control, a microscope optical system, a detection pinhole, and the detectors for detecting the detected or fluorescent light. The illuminating light is coupled in via a beam splitter. The fluorescent or reflected light coming from the specimen travels back through the beam deflection device to the beam splitter, passes through it, and is then focused onto the detection pinhole behind which the detectors are located. Detection light that does not derive directly from the focus region takes a different light path and does not pass through the detection pinhole, so that a point datum is obtained which results, by sequential scanning of the specimen, in a three-dimensional image. A three-dimensional image is usually achieved by acquiring image data in layers, the path of the scanning light beam on or in the specimen ideally describing a meander (scanning one line in the X direction at a constant Y position, then stopping the X scan and slewing by Y displacement to the next line to be scanned, then scanning that line in the negative X direction at constant Y position, etc.). To allow image data acquisition in layers, the sample stage or the objective is shifted after a layer is scanned, and the next layer to be scanned is thus brought into the focal plane of the objective.

The aforementioned Unexamined Application DE 43 30 347 A1 discloses that selection and detection in more than two spectral regions is also possible by cascading the apparatus. The apparatus that is known from DE 199 02 625 A1 describes a clever arrangement of the mirror stops that makes possible selection and detection in four spectral regions. A further cascading of this apparatus is complex, and is possible only at the cost of a degradation in spectral resolution capability.

### SUMMARY OF THE INVENTION

It is therefore an object of the present invention to provide an apparatus for selection and detection of several spectral regions of a light beam that makes possible, with mechanical stability and reliability, the selection and detection of a greater number of spectral regions of a light beam.

The present invention provides an apparatus for selection and detection of at least two spectral regions of a light beam, comprising:

means for spectral spreading of the light beam;

focusing means for focusing the spectrally divided light beam into a focus line;

means, modifiable in their position parallel to the focus line, for blocking out a first spectral region and for reflecting at least a portion of the unblocked spectral region and

a detection device that encompasses means for detecting the first spectral region and means for detecting the reflected spectral region, whereby the detection device is arranged in a plane perpendicular to the focus line

It is also an object of the invention to provide a scanning microscope with which it is possible, with mechanical stability and reliability, to analyze a detection light beam proceeding from the sample in a greater number of spectral regions.

The invention provides a scanning microscope having an apparatus for selection and detection of at least two spectral regions of a light beam comprising:

means for spectral spreading of the light beam;

focusing means for focusing the spectrally divided light beam into a focus line;

means, modifiable in their position parallel to the focus line, for blocking out a first spectral region and for reflecting at least a portion of the unblocked spectral region and

a detection device that encompasses means for detecting the first spectral region and means for detecting the reflected spectral region, whereby the detection device is arranged in a plane perpendicular to the focus line.

The invention has the advantage of making possible selection and detection in a greater number of spectral regions, with a reduced overall size and with great mechanical reliability and stability.

In a preferred embodiment, the detection device is arranged annularly around the means for blocking out a first spectral region and for reflecting at least a portion of the unblocked spectral region.

The means for blocking out a first spectral region and for reflecting at least a portion of the unblocked spectral region are preferably modifiable in their position parallel to the focus line. A motorized drive system, which for example can be embodied as an electric motor, is preferably provided for this purpose. In a preferred embodiment, a motorized drive system is associated with each means for blocking out a first spectral region and for reflecting at least a portion of the unblocked spectral region. A an advantageous embodiment is one in which the motorized drive systems are arranged in at least one plane that is parallel to the plane perpendicular to the focus line. This embodiment preferably exhibits a layered structure, in which the means for blocking out a first spectral region and for reflecting at least a portion of the unblocked spectral region, the means for detection, and the motorized drive systems are arranged in different layers.

In a variant, the motorized drive systems displace the means for blocking out a first spectral region and for reflecting at least a portion of the unblocked spectral region by way of drive rods or drive tubes that preferably are bent. The bent embodiment makes possible an arrangement of the means for blocking out a first spectral region and for reflecting at least a portion of the unblocked spectral region in the vicinity of the focal line, without creating space problems in the placement of the associated motorized drive systems. In a preferred embodiment, the drive rods or drive tubes simultaneously provide guidance. Elements strictly for guidance can also be provided.

In another variant, threaded spindles are provided for transferring the drive energy.

The means for blocking out a first spectral region and for reflecting at least a portion of the unblocked spectral region are preferably arranged in offset fashion in such a way that a collision is ruled out. In a particular embodiment, the means for blocking out a first spectral region and for reflecting at least a portion of the unblocked spectral region are mirror stops. These are preferably embodied as mirror-coated half-cylinders that are insertable into the drive tubes.

The means for blocking out a first spectral region and for reflecting at least a portion of the unblocked spectral region are preferably arranged in the region of the focus line, thereby providing high spectral resolution.

An apparatus that contains twenty-six mirror stops and nine means for detection is particularly efficient. The means for detection are preferably photomultipliers.

In a preferred embodiment, the means for detection are arranged in an annular chassis that has support bases, preferably arranged perpendicular to the tube axis, on which the motorized drives are mountable, and that has an opening for the light beam.

### BRIEF DESCRIPTION OF THE DRAWINGS

The subject matter of the invention is schematically depicted in the drawings and will be described below with reference to the Figures, identically functioning components being labeled with the same reference characters. In the drawings:

FIG. 1 shows a confocal scanning microscope according to the present invention; and

FIG. 2 an apparatus for selection and detection of at least two spectral regions of a light beam; and]

FIG. 3 is a sectioned view of an apparatus for selection and detection of at least two spectral regions of a light beam.

### DETAILED DESCRIPTION OF THE INVENTION

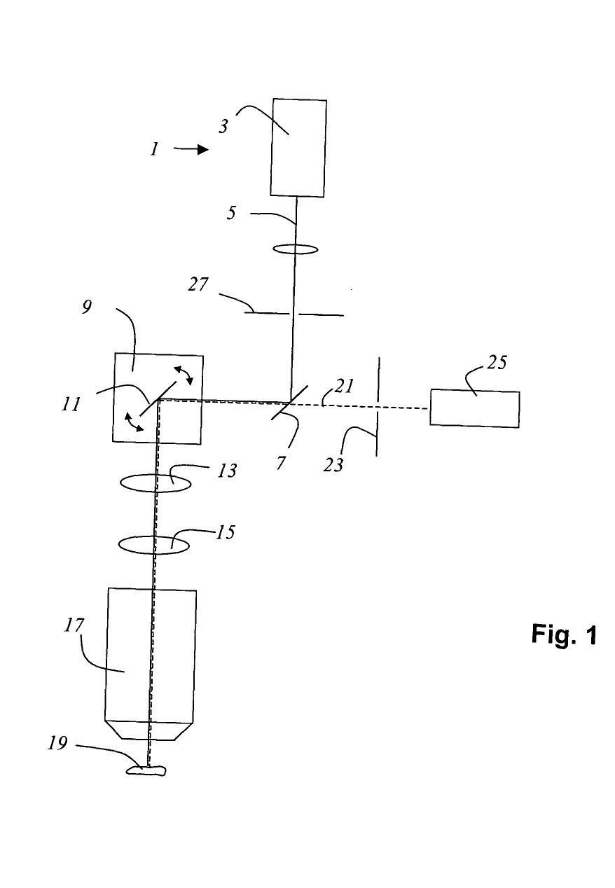

FIG. 1 schematically shows a confocal scanning microscope according to the present invention. The scanning microscope contains a light source 1 that is embodied as a laser 3. Illuminating light beam 5 emitted from laser 3, after passing through an excitation pinhole 27, is reflected by a main beam splitter 7 to a beam deflection device 9 which contains a gimbal-mounted scanning mirror 11, and is guided from beam deflection device 9 through scanning optical system 13, tube optical system 15, and objective 17 over or through sample 19. Detection light beam 21 proceeding from sample 19 travels along the same light path via beam deflection device 9 back to main beam splitter 7, passes through the latter, and after passing through detection pinhole 23 strikes apparatus 25 for selection and detection of at least two spectral regions. In the drawings, illuminating light beam 5 is depicted with solid lines, while detection light beam 21 proceeding from sample 19 is depicted with dashed lines.

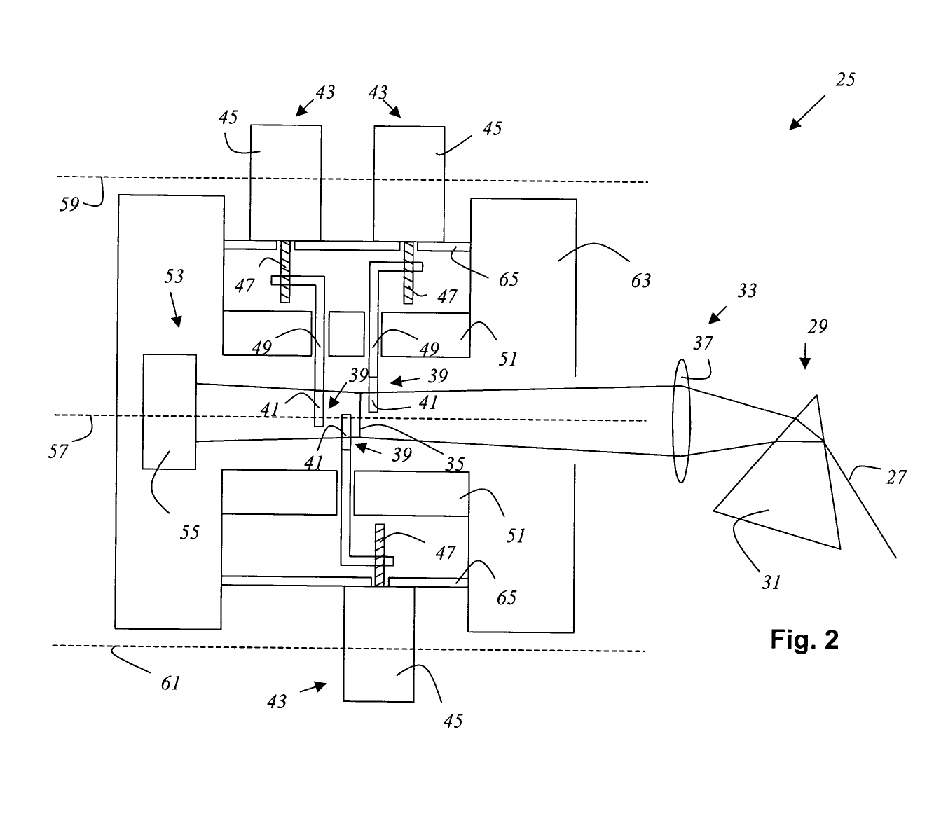

FIG. 2 shows an apparatus 25 for selection and detection of at least two spectral regions of a light beam 27, having a means 29 for spectral spreading of the light beam which is embodied as prism 31. The apparatus contains a focusing means 33, for focusing the spectrally divided light beam into a focus line 35, which is configured as lens system 37. Means 39 for blocking out a first spectral region and for reflecting at least a portion of the unblocked spectral region, which are embodied as mirror stops 41, are arranged in the region of focus line 35. Means 39 for blocking out a first spectral region and for reflecting at least a portion of the unblocked spectral region are displaceable parallel to focus line 35. Motorized drive systems 43, which are embodied as electric motors 45 and which move mirror stops 41 via a spindle drive 47 and via drive rods 49, are provided for displacement. Drive rods 49 are bent, and are guided in guide plates 51. The apparatus furthermore contains a detection device 53 having detectors 55 which are arranged in a plane 57 perpendicular to focus line 35. The motorized drives are arranged in parallel planes 59, 61. Detectors 55 are arranged in an annular chassis 63 in which are provided support bases 65 on which motorized drive systems 43 are mounted.

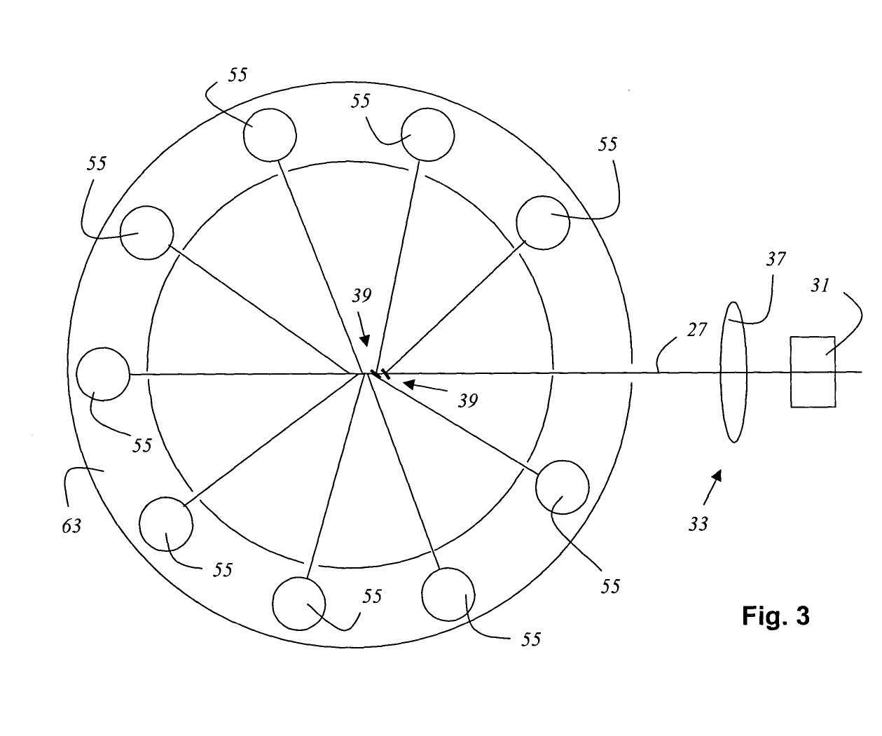

FIG. 3 shows an apparatus 25 for selection and detection of at least two spectral regions of a light beam 27, in a sectioned depiction from above through plane 57, perpendicular to focus line 35, in which detectors 55 are arranged. For reasons of clarity, only two of means 39 for blocking out a first spectral region and for reflecting at least a portion of the unblocked spectral region are schematically shown. Means 29 for spectrally spreading the light beam, and focusing means 33 for focusing the spectrally divided light beam into a focus line 35, are also drawn in schematically.

The invention has been described with reference to a particular exemplary embodiment. It is self-evident, however, that changes and modifications can be made without thereby leaving the range of protection of the claims below.

What is claimed is:

1. An apparatus for selection and detection of at least two spectral regions of a light beam, comprising:
means for spectral spreading of the light beam;
focusing means for focusing the spectrally divided light beam into a focus line;
means, modifiable in their position parallel to the focus line, for blocking out a first spectral region and for reflecting at least a portion of the unblocked spectral region and
a detection device that encompasses means for detecting the first spectral region and means for detecting the reflected spectral region, whereby the detection device is arranged in a plane perpendicular to the focus line

2. The apparatus as defined in claim 1, wherein the detection device is arranged annularly around the means for blocking out a first spectral region and for reflecting at least a portion of the unblocked spectral region.

3. The apparatus as defined in claim 1, wherein the means for blocking out a first spectral region and for reflecting at least a portion of the unblocked spectral region are mounted rotatably.

4. The apparatus as defined in claim 1, further comprising: at least one motorized drive system, with which the means for blocking out a first spectral region and for reflecting at least a portion of the unblocked spectral region are modifiable in their position.

5. The apparatus as defined in claim 1, wherein a motorized drive system is associated with each means for blocking out a first spectral region and for reflecting at least a portion of the unblocked spectral region.

6. The apparatus as defined in claim 5, wherein the motorized drive systems are arranged in at least one further plane that is perpendicular to the focus line.

7. The apparatus as defined in claim 5, wherein the motorized drive systems displace the means for blocking out a first spectral region and for reflecting at least a portion of the unblocked spectral region by way of drive rods or drive tubes

8. The apparatus as defined in claim 7, wherein the drive rods or drive tubes are bent.

9. The apparatus as defined in claim 7, wherein the drive rods or drive tubes provide guidance.

10. The apparatus as defined in claim 7, wherein the means for blocking out a first spectral region and for reflecting at least a portion of the unblocked spectral region are embodied as mirror-coated half-cylinders that are insertable into the drive tubes.

11. The apparatus as defined in claim 1, wherein the means for blocking out a first spectral region and for reflecting at least a portion of the unblocked spectral region are mirror stops.

12. The apparatus as defined in claim 11, wherein twenty-six mirror stops are provided and nine means for detection are provided.

13. The apparatus as defined in claim 1, wherein the means for detection are arranged in an annular chassis.

14. The apparatus as defined in claim 13, wherein the means for detection can be introduced into the annular chassis parallel to the focus line.

15. The apparatus as defined in claim 13 further comprising support bases on which the motorized drives are mountable in the annular chassis.

16. A scanning microscope having an apparatus for selection and detection of at least two spectral regions of a light beam comprising:
means for spectral spreading of the light beam;
focusing means for focusing the spectrally divided light beam into a focus line;
means, modifiable in their position parallel to the focus line, for blocking out a first spectral region and for reflecting at least a portion of the unblocked spectral region and
a detection device that encompasses means for detecting the first spectral region and means for detecting the reflected spectral region, whereby the detection device is arranged in a plane perpendicular to the focus line.

17. The scanning microscope as defined in claim 16, wherein the light beam is a detection light beam.

18. The scanning microscope as defined in claim 16, wherein the detection device is arranged annularly around the means for blocking out a first spectral region and for reflecting at least a portion of the unblocked spectral region.

19. The scanning microscope as defined in claim 16, further comprising at least one motorized drive system, with which the means for blocking out a first spectral region and for reflecting at least a portion of the unblocked spectral region are modifiable in their position.

20. The scanning microscope as defined in claim 16, wherein the scanning microscope is a confocal scanning microscope.
